(19) United States
(12) Patent Application Publication
(10) Pub. No.: US 2003/0012970 A1
(43) Pub. Date: Jan. 16, 2003

(54) Composite wood component with lesser grade quality wood filler core

(76) Inventors: Suzanne Auclair, Saint-Felicien (CA); Francois Huard, Burlington (CA); Christian Perron, Saint-Felicien (CA)

Correspondence Address: OGILVY RENAULT, 1981 MCGILL COLLEGE AVENUE, SUITE 1600, MONTREAL, QC, H3A2Y3, CA

(21) Appl. No.: 10/175,918

(22) Filed: Jun. 21, 2002

Related U.S. Application Data
(63) Continuation-in-part of application No. 09/398,049, filed on Sep. 17, 1999, now abandoned.

(51) Int. Cl. B32B 5/12; B27N 5/02

(52) U.S. Cl. 428/537.1; 428/593; 428/35.6; 428/106; 428/114

(57) ABSTRACT

A composite wood component is comprised of a wood filler core having opposed parallel flat side and end surfaces and opposed parallel top and bottom surfaces. Solid wood trim components are glued to the side and end surfaces of the filler core and oriented with its wood grain extending in a common direction. A solid high quality wood covering is adhesively secured to at least the top surface of the filler core and also has its wood grain oriented in the common direction with the trim components. The wood trim components have a thickness selected to be machined without exposing the wood filler core. The wood filler core is comprised of lower grade quality wood pieces glued together at opposed side edges to form a rectangular or a square core.

This application is a continuation in part of application Ser. No. 09/398,049 filed Sep. 17, 1999.

### FIELD OF THE INVENTION

The present invention relates to a composite wood component having a wood filler core comprising lower grade quality wood pieces. High quality wood trim components of same or various wood species are about the wood core and over at least one flat surface thereof with at least its outer wood grain oriented in a common direction whereby the wood component can be peripherally machined or routed without exposing the lower grade quality wood of the filler core and resembling a component made entirely of high quality wood pieces.

### BACKGROUND OF THE INVENTION

Various composite wood components have been engineered whereby to use a combination of high quality wood pieces and lower grade quality wood pieces whereby to manufacture stairs, furniture, or the like. However, the problem with such wood pieces is that most of them are intended for a specific use and when they are cut or machined such as by edge routing, a portion of the inferior wood core is exposed making the inferior wood visible to the eye. Therefore, such products have very limited use are sold as a finish product for a very specific intended use. Another disadvantage of these composite products is that often the filler core will absorb more humidity than the covering quality wood pieces which are glued thereabout and this causes splitting of the finish product. A still further disadvantage is that when these products are machined, such as by edge routing often the insert pieces are rendered highly visible as their wood grain is not oriented in a common direction and this is particularly so at intersecting corners of a machined wood piece. For this reason these composite wood components were utilized in the construction of less quality products such as furniture, kitchen cabinets, etc.

### SUMMARY OF THE INVENTION

It is a feature of the present invention to provide a composite wood component having a lower grade quality wood filler core and which substantially overcomes the above-mentioned disadvantages of a prior art.

Another feature of the present invention is to provide a composite wood component comprising a wood filler core which utilizes lower grade quality wood pieces and about which is secured high quality wood trim components wherein the grain of these components is oriented in a common direction so that the peripheral contour of the composite wood component can be machined without exposing the lower grade quality wood pieces of the filler core and resembling a composite wood component fabricated entirely from high quality wood pieces.

According to the above features, from a broad aspect, the present invention provides a composite wood component which comprises a wood filler core having opposed parallel flat side and end surfaces and opposed parallel top and bottom surfaces. The wood filler core is comprised of lower quality wood pieces glued together at opposed side edges to form the core. Solid wood trim components are glued to the side and end surfaces of the filler core and oriented with its wood grain extending in a common direction. A solid wood covering is adhesively secured to at least the top surface of the filler core and also has its wood grain oriented in the said common direction. The wood trim components have a thickness selected to be machined without exposing the wood filler core.

### BRIEF DESCRIPTION OF THE DRAWINGS

The preferred embodiments of the present invention will now be described with reference to the accompanying drawings in which

FIG. 1 is an exploded view illustrating the construction of the composite wood component of the present invention;

FIG. 2A is a section view through the composite wood component exposing the lower grade quality wood filler core of the present invention;

FIG. 2B is a fragmented view showing a wood work joint securing an end component ot the filler core;

FIG. 3 is a perspective view of the assembled product as illustrated in FIG. 1;

FIGS. 4A-4D are plan views illustrating the process of fabrication of the composite wood component of the present invention and wherein the opposed solid wood coverings extend to the peripheral edges of the component;

FIG. 4E is a fragmented cross-section view showing the construction of the composite wood component fabricated by the process of FIGS. 4A to 4D;

FIGS. 5A-5D illustrate a further embodiment of the process of manufacturing the composite wood component of the present invention and consist of plan view showing various stages of this process;

FIG. 5E is a fragmented cross-section view showing the composite wood component assembled by the process of FIGS. 5A-5D; and

FIG. 6 is a fragmented perspective view of a portion of the composite wood component of the present invention as utilized in the fabrication of a kitchen cabinet door and wherein the peripheral edge surface of the wood component has been machined to form an ornamental design.

### DESCRIPTION OF PREFERRED EMBODIMENTS

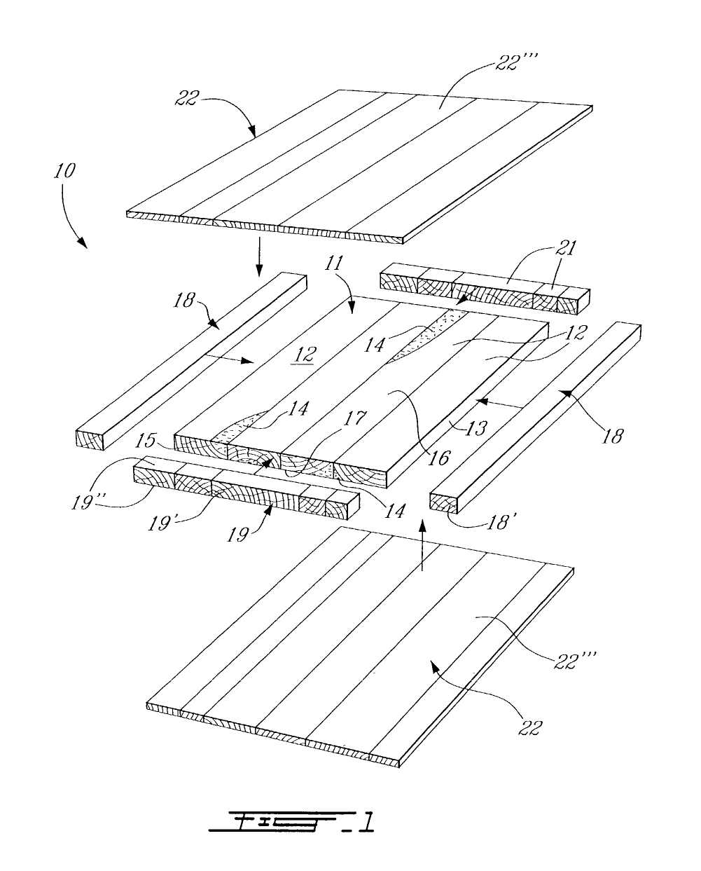

Referring now to the drawings and more particularly to FIGS. 1 to 3 there is shown generally at 10 the various wood pieces which constitute the composite wood component of the present invention. As hereinshown the composite wood component 10 is comprised of a wood filler core 11 which consists of lower grade quality wood pieces 12 preferrably but not exclusively of equal width and having substantially rectangular cross-section and wherein their side edges 13 are glued together, under pressure, to form a a substantially rectangular filler core 11. As hereinshown all of these wood pieces 12 or at least most of them are lower grade quality wood products which have heart wood sections 14 or other defects therein. These wood pieces 12 are usually recycled in lesser quality applications at the mill as they cannot be utilized in the construction of high quality wood products such as furniture, kitchen cabinets, bookshelves, etc.

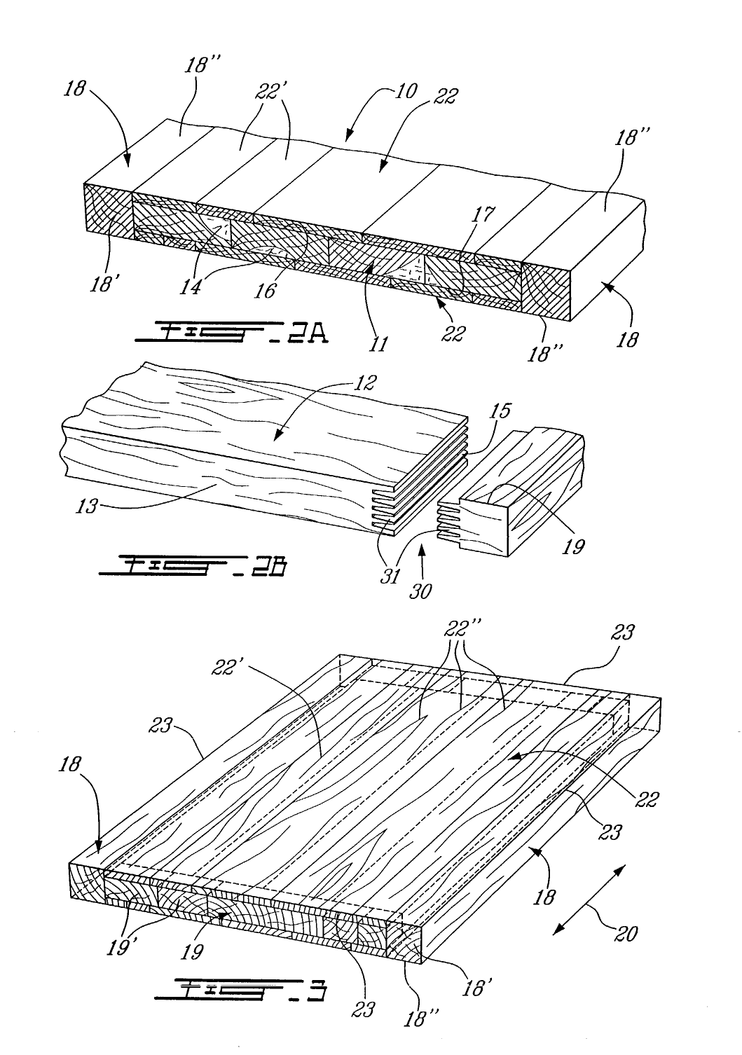

The wood filler core 11, once assembled, defines opposed parallel flat side and end surfaces 13 and 15 respectively, and opposed parallel top and bottom surfaces 16 and 17. Solid wood trim components, herein side components 18 and end components 19 are glued to the side surfaces 13 and end surfaces 15, respectively. As hereinshown these side and end components 18 and 19, have a wood grain 18′ and 19′, respectively, which is oriented in a common direction as herein illustrated by arrow 20 in FIG. 3. The end components 19 are also formed by a plurality of wood pieces 21 which are also glued in a side-by-side relationship and each having their grain oriented along the common direction 20. The side components 18 and end components 19 have lower and upper flat parallel surfaces 18″ and 19″, respectively.

In order to conceal the wood filler core 11 in at least one side face of the composite wood component 10 a solid wood covering or cover sheet 22 is adhesively secured over at least the top surface 16 of the wood filler core 11 FIGS. 2 and 3. As shown in FIG. 2A the composite wood component 10 has the wood cover sheet 22 extending over the top surface 16 of the filler core 11 intermediate the side components 18. As hereinshown the wood cover sheet 22 is applied to both the top surface 16 and the bottom surface 17 of the wood filler core 11. The outer surface 22′ of the wood cover sheet 22 terminates flush with the inner surface 18″ of the side components 18 and it also extends flush to the end components 19 to produce a finish composite wood component which has an exterior appearance as consisting solely of high quality wood components. One of the advantages of constructing the composite wood component as herein described is that the entire peripheral edge 23 of the composite wood component 10 can be machined such as with a router to form a bevel or architectural edge as illustrated at 24 in FIG. 6. It also gives the appearance that it is formed only of high quality wood pieces. Additionally, the thickness of the wood cover sheet 22 is selected to suit the use of the composite wood component and may be thicker if the surface thereof is intended to be machined to provide a door architectural design. As shown in FIG. 3, the wood grain 22″ of the top cover sheet 22 and the wood grain 18′ and 19′ of the side components 18 and end components 19 all extend in the common direction 20. Accordingly, once the peripheral edge of the composite wood component is machined, the wood grain which is exposed extends in the said common direction 20 as is the case with solid wood pieces extending across the component and none of the imperfections 14 of the filler core 11 are exposed. In fact, none of the wood pieces 12 of the filler core 11 are exposed.

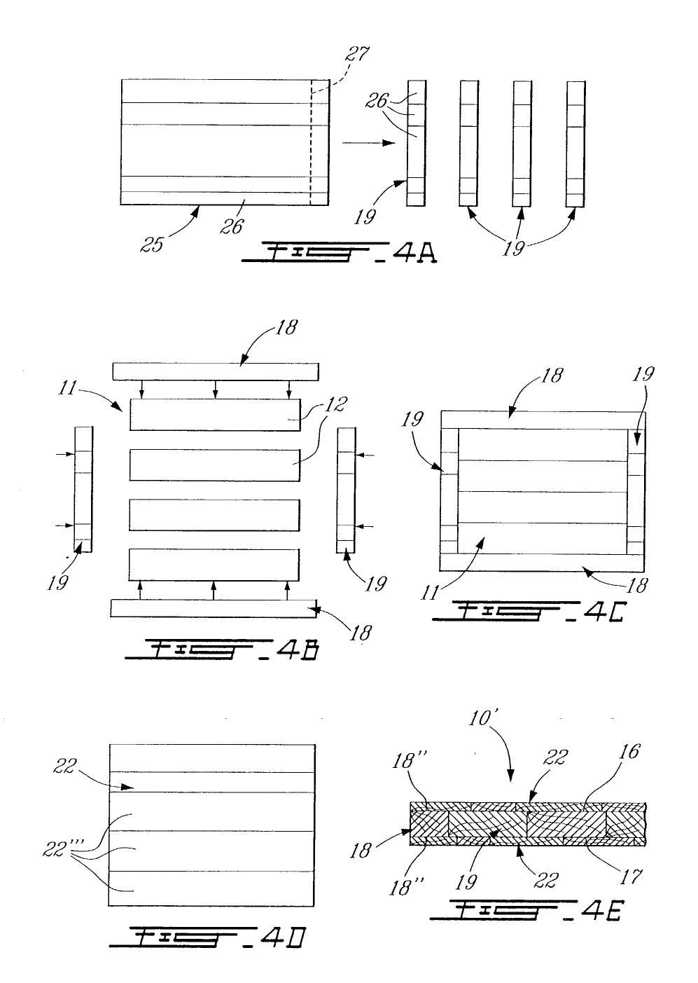

FIGS. 4A to 4D illustrate one embodiment of the process of fabricating of the composite wood component 10 of the present invention and as illustrated in FIG. 4E the composite wood component 10′ differs slightly from the component 10 as shown in FIG. 3 and wherein the top and surfaces 18″ of the side components 18. They also extend over the end components 19. As shown in FIG. 4A the butt ends or end components 19 are fabricated from an elongated rectangular or square panel which is formed of a plurality of elongated quality wood pieces 26 of a rectangular cross-section and of a common thickness, and which are glued together under pressure in a side-by-side relationship. The panel 25 is then sliced or cut transversally, as illustrated by phantom line 27, to form the end components 19 of predetermined width. These panels 25 are fabricated in a manner well known in the art whereby the glue is applied to them and they are then pressed together until the glue curing occurs. It is also pointed out, and as seen from FIG. 2A, the end components 19 which consist of the laminated high quality wood pieces 26 may then be fixed to the end of the filler core 11 through a butt joint or a wood work joint 30 such as with spliced grooves or a tongue and groove connection 31 which are covered with glue and then press fit together, as illustrated in FIG. 4B to form the interim product illustrated in FIG. 4C. At this stage the wood overlay or cover panels 22 which also consist of wood pieces 22′″, glued together along their longitudinal edges, are then glued to the top and bottom surfaces 16 and 17 of the filler core 11 to produce a composite product as shown in FIG. 4E.

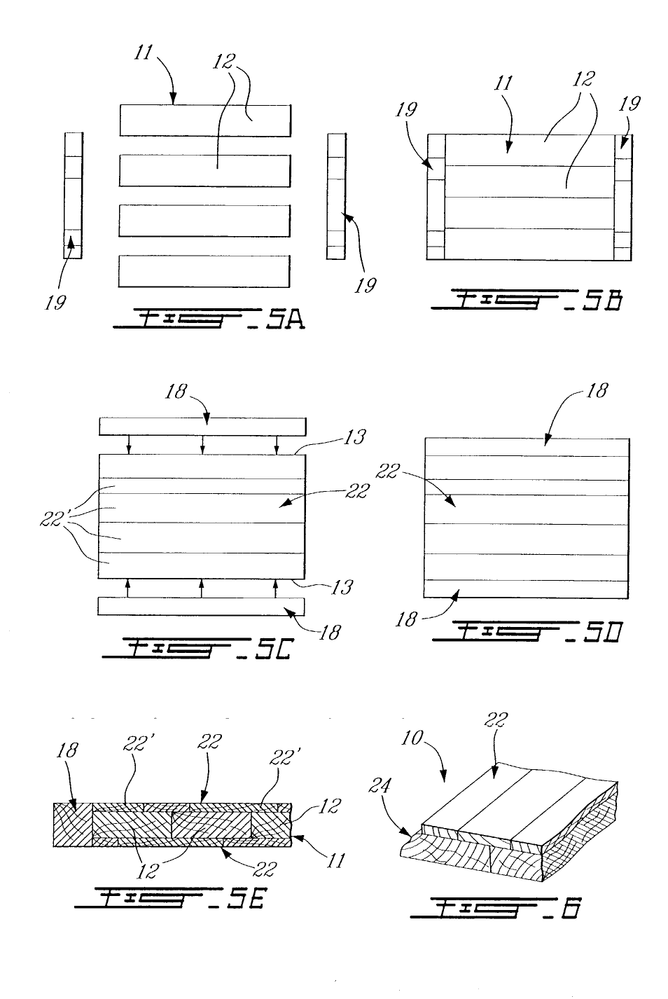

FIGS. 5A to 5D illustrate substantially the same process as shown in FIGS. 4B to 4D but wherein the side components 18 are applied to the side edge surfaces 13 of the core 11 only after the cover sheet 22 has been glued to the top and bottom surfaces of the core 11. This produces a slightly different cross-section configuration of the composite wood component 10 as illustrated in FIG. 5E and as previously described with reference to FIGS. 2 and 3.

The composite wood component 10 manufactured with these processes or other equivalent processes can produce rectangular or square panels of predetermined dimensions and of 4 inches to 48 inches and a thickness of | inch to 2 inches. These dimensions can also vary depending on the specific applications of these composite wood components. The overlay sheets 22 are made of sliced or rotary high quality wood with different face grain patterns that covers the filler core and the peripheral machinable surfaces, and may have dimensions such as lengths of 12 inches to 96 inches or more, a width of 4 inches to 48 inches and an appropriate thickness depending on the application.

It is pointed out that it is within the ambit of the present invention to cover any obvious modifications of the preferred embodiment described herein provided such modifications fall within the scope of the appended claims. The quality composite wood component 10 as herein described as several advantages in that its laminated construction provides for an engineered glued panel which has excellent stability and which increases the yield factor of lumber recovery due to the use of lower grade quality wood for the filler core. It also maximizes the high quality wood by utilizing slicing or rotary methods to produce the required overlay sheets. High quality wood is utilized only for the peripheral machinable wood surface and this enables for the wood component to be machined about its periphery and also about its opposed surfaces within the thickness of the cover sheets. The wood grain is also oriented in a common direction to enhance the appearance of the composite wood component and the finished product which is usually machined. Accordingly, this composite wood component is comparable to a component fabricated entirely with high quality wood pieces and may be used in the fabrication of furniture for home and office use, kitchen cabinets, stair systems, bed frames, bookshelves and various other uses as is obvious to a person skilled in the art. As also previously described the composite wood component may have a cover sheet 22 affixed to only one side thereof if the reverse side is concealed, such as in the construction of a table top, a panel, etc. It is also possible to orient the wood grain of the overlay sheet only in a transverse direction to create different architectural effects. The composite wood component may also have a shape which is not rectangular or square.

1. A composite wood component comprising a wood filler core having opposed parallel flat side and end surfaces and opposed parallel top and bottom surfaces, said wood filler core being constructed from lower grade quality wood pieces glued together at opposed side edges to form said core, solid wood trim components glued to said side and end surfaces of said filler core, and a solid wood covering layer formed by a single wood layer having a plurality of wood pieces glued together side-by-side and adhesively secured to at least said top surface of said filler core, said wood trim components glued to said side and end surfaces of such filler core being substantially thicker than said solid wood covering layer, said wood trim components having a thickness selected to be longitudinally machined without exposing said wood filler core, said wood trim components and said solid wood covering layer being quality wood components each having a wood grain which is exteriorly visible and which extends in a common direction with one another to produce said composite wood component having an exterior appearance of a high quality wood component.

2. A composite wood component as claimed in claim 1 wherein there is one of said solid wood covering layer adhesively secured to both said top and bottom surfaces of said wood filler core.

3. A composite wood component as claimed in claim 2 wherein said plurality of wood pieces are of equal width.

4. A composite wood component as claimed in claim 3 wherein said solid wood covering sheet overlaps a top and bottom surface of said solid wood trim components, said solid wood trim components having upper and lower flat parallel surfaces terminating flush with said top and bottom surfaces of said wood filler core.

5. A composite wood component as claimed in claim 3 wherein said solid wood covering sheet overlaps said opposed parallel top and bottom surfaces of said wood filler core, said solid wood trim components having upper and lower flat parallel surfaces, each said upper and lower flat parallel surfaces terminating flush with a flat outer surfaces of respective one of said wood covering sheet glued to said upper and lower flat parallel surfaces.

6. A composite wood component as claimed in claim 2 wherein said solid wood trim components and said solid wood covering layer is formed from selected wood pieces which are free of wood defects.

7. A composite wood component as claimed in claim 1 wherein said lower grade wood of said wood pieces is heart wood or other type wood having defects therein and having a different texture and density than said wood trim components and said solid wood covering layer.

8. A composite wood component as claimed in claim 1 wherein said composite wood component is formed as a rectangular, square panel or other suitable shape.

9. A composite wood component as claimed in claim 1 wherein said wood filler core is comprised of a plurality of elongated rectangular wood pieces of substantially equal cross-section and glued together in side-by-side relationship.

10. A composite wood component as claimed in claim 1 wherein said solid trim components are adhesively secured to said filler core through one of a butt joint or woodwork joint.

11. A composite wood component as claimed in claim 10 wherein said woodwork joint is one of a spliced grooves or a tongue and groove connection covered with adhesive and press fit together.
